(19) United States
(12) Patent Application Publication
(10) Pub. No.: US 2026/0320337 A1
(43) Pub. Date: Oct. 15, 2026

(54) Hybrid Physical-Digital Organizational System

(71) Applicants: Sanjay Majumder, Costa Mesa, CA (US); Neal Anderson, Indianapolis, IN (US)

(72) Inventors: Sanjay Majumder, Costa Mesa, CA (US); Neal Anderson, Indianapolis, IN (US)

(73) Assignees: Sanjay Majumder, Costa Mesa, CA (US); Neal Anderson, Indianapolis, IN (US)

(21) Appl. No.: 19/177,869

(22) Filed: Apr. 14, 2025

(51) Int. Cl. G06K 19/07; G06K 19/06

(52) U.S. Cl. CPC G06K 19/0723; G06K 19/06037

(57) ABSTRACT

A hybrid physical-digital organizational system integrates tactile interaction with dynamic digital synchronization through: (1) physical cards in at least one of multiple formats (poker-size: 2.5″×3.5″; tarot-size: 2.75″×4.75″) with embedded machine-readable data (QR/NFC/RFID); (2) a mountable mechanical selection mechanism (rotating wheel with card slots or sliding track with modular dividers); (3) a structured 4×2 grid organizer with mounting features; and (4) a digital platform enabling real-time content updates via card scanning. The system is particularly suited for instructional content organization (recipes, tutorials, educational sequences) while maintaining functionality for other sequential workflows. Physical components provide tactile engagement, while the digital platform offers dynamic content editing, community sharing, and compatibility with emerging technologies (Artificial Intelligence, augmented reality, voice assistants). Cards support both printed instructional content and digitally updatable elements, bridging the gap between static physical materials and complex digital platforms.

### FIELD OF THE INVENTION

The present invention relates to a hybrid organizational system integrating physical and digital components, including but not limited to physical cards, a selection mechanism, a structured organizer, and a digital platform for interactive planning and execution of instructional content (e.g., recipes, tutorials, educational sequences) and other sequential workflows.

### BACKGROUND OF THE INVENTION

Existing systems for organizing instructional content fall into two categories: digital platforms and static physical materials. Digital platforms, such as meal planning apps and educational software, offer real-time updates but lack tactile engagement. Static physical materials, such as printed recipe books or lesson planners, provide hands-on interaction but cannot be dynamically updated.

There is a need for a system that bridges this gap by combining the tactile benefits of physical organization tools with the adaptability of digital platforms, particularly for instructional content that benefits from both structured sequencing and flexible updates.

### SUMMARY OF THE INVENTION

The invention comprises a hybrid system particularly suited for (but not limited to) instructional content organization, including:

a. Physical cards with printed or embedded digital content
b. Mechanical selection devices (rotating wheel, sliding track)
c. A structured grid-based organizer for structured sequencing
d. A digital platform enabling real-time updates and content remixing

### BRIEF DESCRIPTION OF DRAWINGS

FIG. 1 Illustration of various physical card designs, highlighting differences in size, formats, orientation, and visual style.
a. FIG. 1A—Compact Portrait Card (Front, Light Design)
b. FIG. 1B—Compact Portrait Card (Back, Universal)
c. FIG. 1C—Compact Portrait Card (Front, Dark Design)
d. FIG. 1D—Mid-Sized Landscape Card (Front, Light Design)
e. FIG. 1E—Mid-Sized Landscape Card (Back, Universal)

FIG. 2 illustrates the rotating wheel selection mechanism including the rotating wheel variation.
a. FIG. 2A—Drawing of wheel front with demonstration of card insertion & removal
b. FIG. 2B—Drawing of wheel front, actively spinning, with cards inserted
c. FIG. 2C—Drawing of wheel back, demonstrating mounting holes and recessed spot for magnets (tilted slightly to show card insertion region at top of wheel)
d. FIG. 2D—Exploded view of the wheel selection mechanism, illustrating assembly of components. Tilted top-down perspective to show card insertion region, recessed finger holes for ease of spinning, and alignment of structural elements prior to assembly.
e. FIG. 2E—Assembled view of the wheel selection mechanism, tilted top-down to emphasize the card insertion region. Showcases the geometric central card stopper, positioned beneath the card catch lip to ensure secure placement and rotation stability.

FIG. 3 depicts the structured grid organizer, showing the 4×2 grid layout with designated slots for cards.
a. FIG. 3A—Drawing of planning grid (front, empty)
b. FIG. 3B—Drawing of planning grid (back) with mounting holes and recessed spot for magnets
c. FIG. 3C—Drawing of planning grid (front) with demonstration of card insertion & removal
d. FIG. 3D—Drawing of planning grid (front, full of inserted cards)

FIG. 4 demonstrates the digital platform interface, representing textual content related to the physical cards.
a. FIG. 4A—Digital Platform Interface (Portrait mode, minimal light design with a scroll bar for overflowing text within a minimalist card interface. Includes physical card details.)
b. FIG. 4B—Digital Platform Interface (Landscape mode, minimal light design. Includes physical card details.)
c. FIG. 4C—Digital Platform Interface (Portrait mode, minimal dark design with a scroll bar for overflowing text within a minimalist card interface. Includes physical card details.)
d. FIG. 4D—Digital Platform Interface (Landscape mode, minimal dark design. Includes physical card details.)

FIG. 5 presents the system interaction flowchart, showing the interaction between physical components and the digital platform.

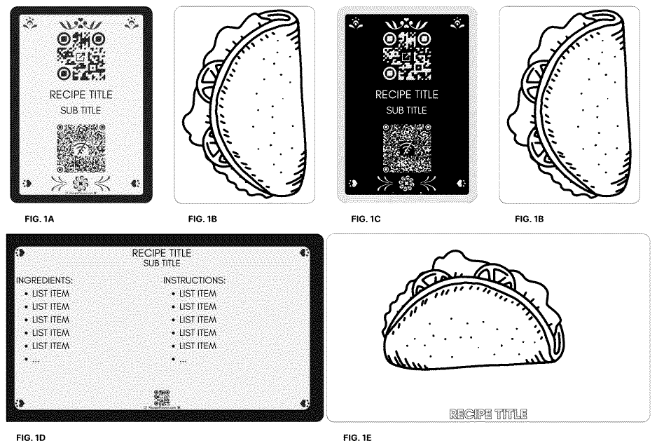

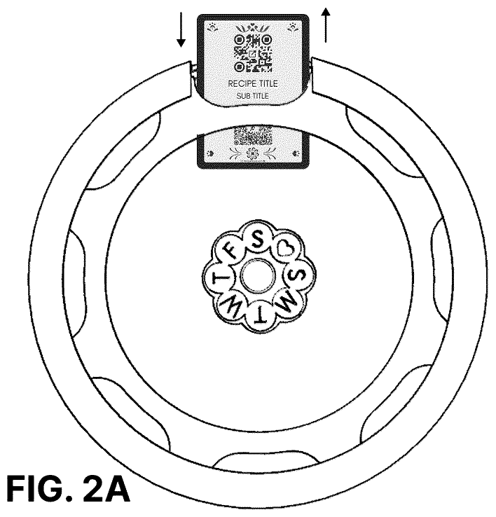

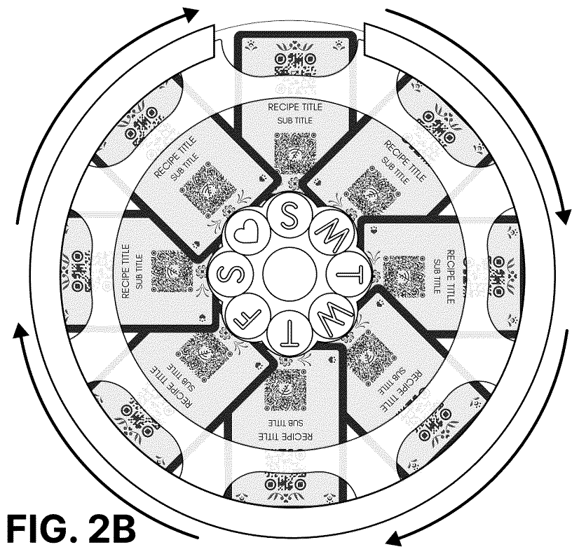

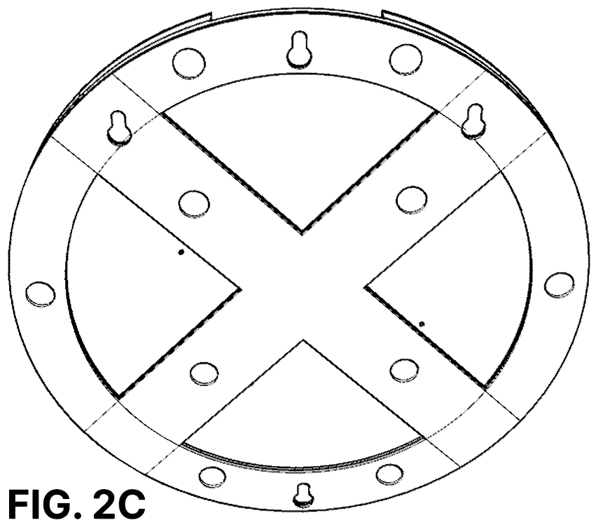

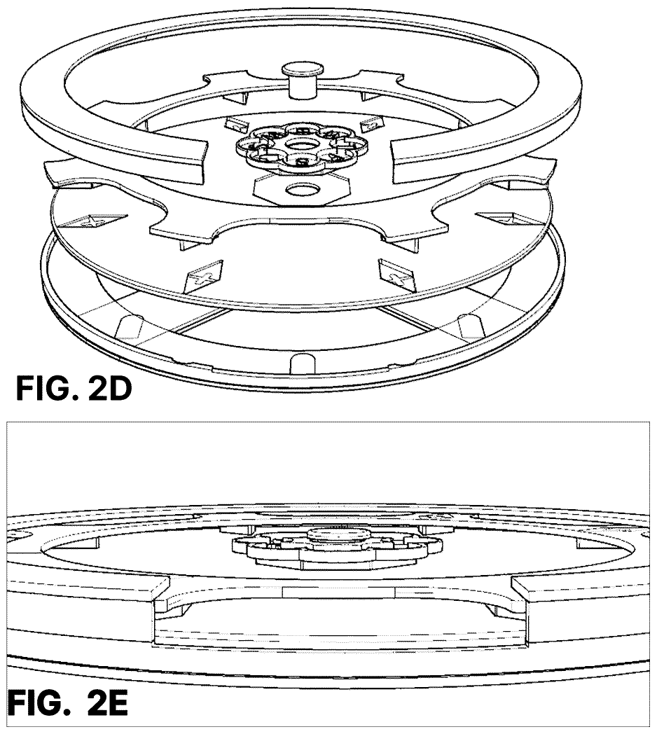

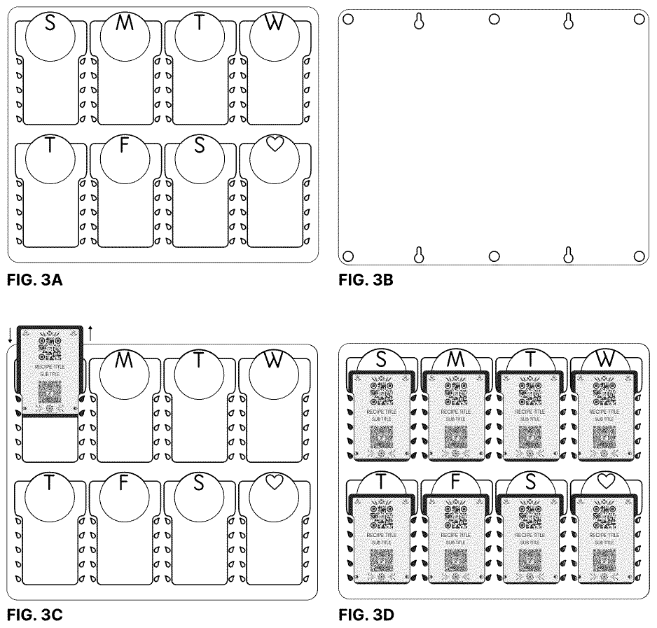

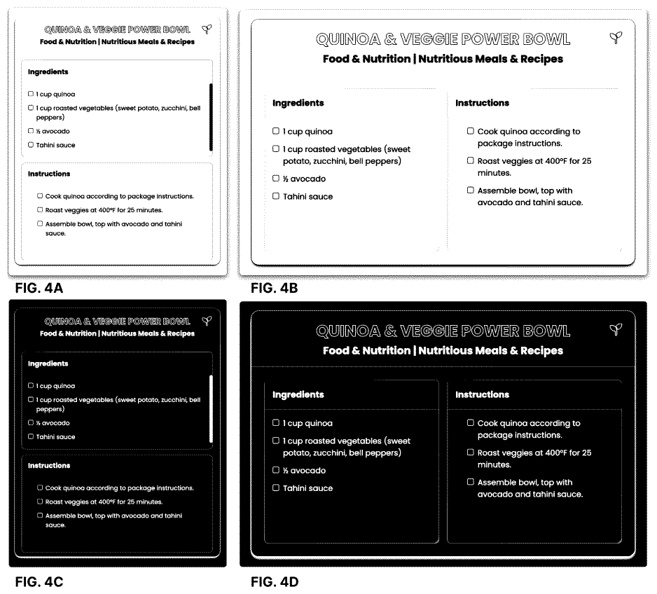

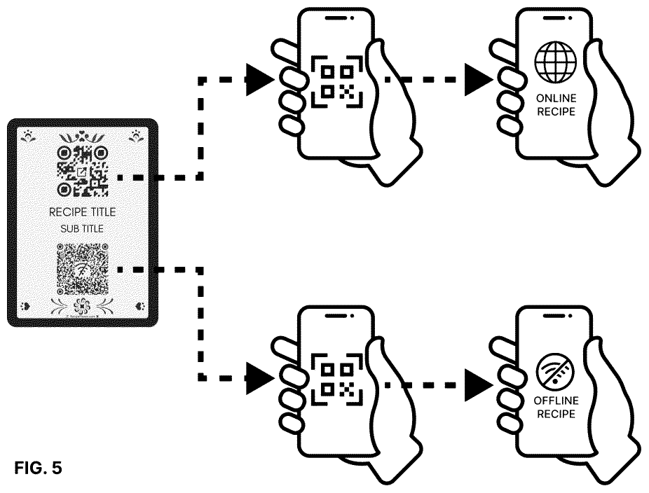

### DETAILED DESCRIPTION OF THE INVENTION

### Physical Cards

The system includes a set of physical cards available in at least one of multiple formats, such as poker-size (2.5″×3.5″), tarot-size (2.75″×4.75″), or custom dimensions. Each card contains:
a. Printed content (text or images) configured for instructional or organizational use
b. Digitally embedded data (QR codes, NFC, RFID, or other) linking to dynamic digital content as well as offline embedded content in formats such as vCards.
c. A secondary scannable or wireless feature enabling real-time updates
d. Durable construction from laminated cardstock or plastic
e. Design variations including light/dark themes and portrait/landscape orientations

While particularly effective for instructional content like recipes, tutorials, and educational sequences, the system maintains full functionality for other organizational purposes including media playlists and project management.

### Selection Mechanism

The system includes a physical device configured to allow users to manually or randomly choose cards:

### Rotating Wheel Variation

a. Circular frame with magnetized slots for card retention
b. Recessed finger holes for ergonomic spinning
c. Geometric central stopper to ensure proper alignment

### Sliding Track Variation

a. Linear track with smooth grooves for card sliding
b. Modular dividers for customizable sections

Constructed from lightweight yet durable materials such as acrylic, wood, or injection-molded plastic.

### Structured Organizer

The structured grid-based organizer features:
a. A 4×2 layout with eight slots (Sunday-Saturday plus one backlog slot)
b. Mounting holes for wall installation
c. Recessed magnet spots to secure cards
d. Durable materials (acrylic or wood) with smooth finish
e. Adaptable for meal planning, educational sequencing, or project management

### Digital Integration

The web and mobile platform provides:
a. Real-time synchronization via at least one of: QR codes, NFC tags, or RFID chips
b. Dynamic content updates including recipe adjustments and tutorial edits
c. Community features for sharing and remixing content

Minimalist user interface with:
a. Light and dark themes
b. Responsive design for all device orientations
c. Details represented from physical card and scrollable card interfaces

Compatibility with emerging technologies including:
a. Augmented reality integration
b. Artificial Intelligence
c. Voice assistant functionality
d. Offline operation modes

1. A hybrid organizational system comprising: a plurality of physical cards containing machine-readable content; a mechanical selection device configured to arrange said cards in user-selectable configurations; a structured organizer with designated slots for card insertion; and a digital platform synchronizing with said cards via at least one of QR codes, NFC tags, or RFID chips.

2. The system of claim 1, wherein the physical cards have dimensions selected from at least one of poker-size (2.5″×3.5″) or tarot-size (2.75″×4.75″).

3. The system of claim 1, wherein the mechanical selection device comprises a rotating wheel having slots for card retention, recessed finger holes for manual spinning, a geometric central stopper for alignment, embedded magnets for magnetic attachment to ferrous surfaces, and mounting holes for wall installation.

4. The system of claim 1, wherein the mechanical selection device comprises a sliding track with modular dividers configured to allow selective arrangement and retrieval of physical cards.

5. The system of claim 1, wherein the structured organizer comprises a 4×2 grid having slots labeled for days of the week, a dedicated backlog slot, embedded magnets for magnetic attachment to ferrous surfaces, and mounting holes for wall installation.

6. The system of claim 1, wherein the digital platform is configured to provide real-time content updates upon scanning a physical card.

7. The system of claim 1, wherein the digital platform enables user-generated content remixing with attribution tracking.

8. The system of claim 1, wherein the physical cards comprise at least one of laminated cardstock or molded plastic.

9. The system of claim 1, wherein the digital platform features a responsive interface supporting light and dark themes, portrait and landscape orientations, and scrollable card detail views.

10. The system of claim 1, wherein the physical cards are configured to display instructional content selected from at least one of recipes, tutorials, or educational sequences.
